(19) United States
(12) Patent Application Publication
(10) Pub. No.: US 2010/0019179 A1
(43) Pub. Date: Jan. 28, 2010

(54) Solenoid for a Pilot Operated Water Valve Having Reduced Copper and Increased Thermal Efficiency

(75) Inventor: Tam Nguyen, Orland Park, IL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Carol Stream, IL (US)

(21) Appl. No.: 12/178,977

(22) Filed: Jul. 24, 2008

(51) Int. Cl. F16K 31/02

(52) U.S. Cl. 251/129.15

(57) ABSTRACT

A solenoid for a pilot operated water valve having reduced copper and increased thermal efficiency is provided. The solenoid utilizes smaller gauge copper wire for the coil, and reconfigures the coil to a shorter, fatter mechanical design than prior solenoids. Despite the focus of reducing material cost, the pole frame of the solenoid utilizes thicker material than the prior pole frame. This thicker material aids in the thermal performance of the solenoid. A pilot operated valve utilizing such a reduced copper solenoid is also provided.

### FIELD OF THE INVENTION

This invention generally relates to pilot operated valves, and more particularly to the design and construction of the solenoids for actuating pilot operated water valves.

### BACKGROUND OF THE INVENTION

Valves are used in may applications wherein the control of the flow of a process fluid is needed. Such process fluids may include liquids such as oil, fuel, water, etc., or gases such as, e.g., natural gas, oxygen, etc. Some valves operate to meter the flow of fluid therethrough and operate by accurately positioning the valving member to control the amount of fluid allowed to pass through the valve. Other valves operate in a switching fashion wherein the flow of fluid therethrough is either turned on or turned off. Such valves may be utilized, for example, in consumer and commercial appliances such as washing machines, etc., whereby water is allowed to flow for a predetermined period of time or until a predetermined volume has been dispensed therethrough. The control of the operation of such valves is typically performed by an electronic control circuit, such as a micro processor-based controller, along with its associated drive circuitry, to open and/or close the valving member within the valve.

A problem with such switching valves is the force necessary to open the valving member against the static pressure of the process fluid acting on one side of the valving member. Depending on the application, this pressure may be quite high, particularly when compared with the low pressure on the opposite side of the valving member which, in many appliance applications, is at atmospheric pressure. In addition to the static fluid pressure acting on the valving member tending to keep it closed, many such switching valves also include a spring positioned to apply a force on the valving member. This spring force allows the valve to be closed upon the removal of a drive signal, and maintains a bias force on the valving member to keep it closed.

In such configurations, the valve actuator must overcome both the static fluid pressure, which can be quite high and may vary from installation to installation, as well as the spring force, both of which are acting to keep the valve closed. Once these two forces have been overcome, however, the force necessary to continue to open the valve to its fully open position is substantially reduced as the pressure differential across the valving member face drops dramatically. Once this pressure has been equalized, the only remaining force against which the actuator must act is the spring force.

Many electronically controlled switching valves include an electrically actuated solenoid to directly act on a plunger connected to the valving member to move the valving member to its open position. Unfortunately, due to the high pressure differentials that exist for a closed valve and the spring force, the actuator needs to be relatively large so that it is able to reliably operate the valve under all operating conditions and installations. In many industries, such as the consumer appliance industry, strict Governmental and certifying agency requirements place a heavy premium on an electric power usage. As such, these direct acting solenoid controlled valves that include solenoids sized to reliably open the valving member provide a significant disadvantage to the appliance manufacturer in being able to attain agency certification as, for example, as an Energy Star appliance rated appliance. Further, the appliance industry is highly competitive and the cost of such large solenoid actuators also provides a significant detriment to their use.

To overcome these problems many manufacturers have gone to a pilot valve design that allows for a significantly reduced size solenoid actuator to be used to operate the valve. One such pilot operated water valve 99 is illustrated in FIG. 12. Specifically, a pilot operated valve 99 utilizes a relatively small solenoid 101 to be used to move a plunger 103 open a small pilot valve having a small pilot opening 107 in the valving section 103. When opened, this pilot valve allows a small amount of water to flow and open a diaphragm using the principle of differential pressure and surface area. The diaphragm then opens the main valving member that controls the main flow of the process fluid. In other words, pilot operated valves 99 take advantage of the energy of the process fluid pressure to do most of the work to open and close the valve.

Since the solenoid 101 now need only open the small pilot valve, its size may be substantially reduced. This small size results in a lower energy usage as well as lower costs, both providing a significant advantage in many industries, such as the consumer appliance industry. As a result, appliance manufacturers, such as the assignee of the instant application, provide literally millions of pilot operated water valves each year.

These small solenoids 101 include a solenoid coil 109 of approximately 7055 turns of 38 AWG (American wire gauge) gauge copper wire wound on a bobbin 111, which uses approximately 28 grams of copper. The coil 109 and bobbin 111 are then over molded within encapsulation 113. The solenoid 101 also includes a ferromagnetic pole frame 117 having an air gap 119 in the magnetic path thereof. The ferromagnetic pole frame 117 is constructed from a pair of brackets 121, the construction of which may best be understood through an analysis of FIGS. 13-15.

As shown in FIGS. 13-15, the brackets 121 include a sidewall 123 and an end wall 125, each approximately 1.2 mm thick. The height of the sidewall 123 is approximately 30 mm and the length of end wall 125 is approximately 27.5 mm. Each of the side wall 123 and the end wall 125 are approximately 15 mm wide. The brackets 121 also include a centrally located draw 127 forming a pole piece approximately 0.85 mm thick and approximately 11.6 mm tall. A pair of mating tabs 129 extend from end wall 125 and mate with the mating slots 131 seen in FIG. 15 formed on the sidewall 123. These cooperative structures 129, 131 allow two opposed brackets to form the magnetic circuit 117 shown in FIG. 12. This provides a height to width ratio of the solenoid 101 of greater than 1.0.

While the pilot operated water valves provide a substantial reduction in the solenoid actuator size, and therefore cost, over direct acting solenoid actuated valves, the solenoids still rely on copper wire windings to generate the magnetic force needed to operate the pilot valve actuator. Unfortunately, the costs of copper has increased more than three hundred percent in recent years. This significant price increase has significantly increased the cost of the solenoid actuator coil to a point where the solenoid coil now provides a significant cost of the valve as a whole (about fifty percent). Unfortunately, in such a competitive industry, the difference of only a few cents can make or break a major sale. With the forecast showing continuing increases in the cost of copper as well as other raw materials used to construct the solenoid actuators, there exists a need in the art for a new solenoid coil design that reduces the material costs by reducing the amount of copper used to form the solenoid coil. Countering this copper reduction effort, however, is the requirement for reliable operation at each actuation and continued long life of such valves.

Embodiments of the present invention provide such a solenoid for a pilot operated water valve having reduced material costs while still providing reliable actuation and long operational life. These and other advantages of the invention, as well as additional inventive features, will be apparent from the description of the invention provided herein.

### BRIEF SUMMARY OF THE INVENTION

In view of the above embodiments of the present invention provide a new and improved solenoid for a pilot operated water valve. More particularly, embodiments of the present invention provide a new and improved solenoid for a pilot operated water valve having reduced material costs realized through a reduction in the amount of copper used in the solenoid coil therein. Still more particularly, embodiments of the present invention provide a new and improved solenoid for a pilot operated water valve having reduced material cost and increase thermal efficiency that will provide enhanced operational life. Other embodiments of the present invention provide a new and improved pilot operated water valve that utilizes a solenoid in accordance with the teachings of the present invention.

In one embodiment, the solenoid for a pilot operated water valve for use in an appliance includes a coil of less than 38 AWG copper wire having less than seven thousand turns. A magnetic pole frame that is positioned around the coil has a height to width ratio of less than one, a center draw less than 11 mm in length, a wall thickness of greater than 1.2 mm, and a surface area of greater than 17 cm². Preferably, the copper wire is 40 AWG copper wire having six thousand seven hundred fifty turns. In one embodiment the height to width ratio is about 0.73. Preferably, the center draw is approximately 6.7 mm in length, the wall thickness of the magnetic pole frame is about 1.5 mm and the surface area is about 23 cm².

An embodiment of a pilot operated water valve constructed in accordance with the teachings of the present invention, includes a coil of 40 AWG copper wire, a magnetic pole frame positioned around the coil in magnetic proximity thereto having a height to width ratio of less than one, a plunger slidably positioned coaxial with a magnetic axis of the coil between a quiescent position wherein a first end is in contact with a pilot aperture and an activated position wherein the first end of the plunger is not in contact with the pilot aperture, and a spring operably positioned in contact with a second end of the plunger to apply a bias force thereto to maintain the plunger in its quiescent position.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional illustration of a pilot operated water valve incorporating a solenoid constructed in accordance with the teachings of the present invention;

FIG. 2 is a cross-sectional illustration of an L bracket forming a component of an embodiment of the solenoid of the present invention;

FIG. 3 is a top view illustration of the L bracket of FIG. 2;

FIG. 4 is an end view illustration of the L bracket of FIG. 2;

FIG. 5 is a graphical illustration showing force versus coil height of a solenoid coil;

FIG. 6 is a partial cross-sectional illustration of three embodiments of a solenoid that may be used to control a pilot operated water valve;

FIG. 7 is a graphical illustration illustrating average force versus stroke for various embodiments of solenoids for use with a pilot operated water valve;

FIG. 8 is a graphical illustration illustrating heat rise and fall during a duty cycle test of various embodiments of solenoids for use with a pilot operated water valve;

FIG. 9 is a cross-sectional illustration of a pilot operated water mixing valve illustrating the differences between an embodiment of a solenoid constructed in accordance with the teachings of the present invention and a prior solenoid;

FIG. 10 is an isometric side view illustration of the pilot operated mixing valve of FIG. 9 included to illustrate the differences between the prior solenoid and an embodiment of a solenoid constructed in accordance with the teachings of the present invention;

FIG. 11 is a top view isometric illustration of the mixing valve of FIG. 9 illustrating further differences between the prior solenoid valve and one embodiment of a solenoid constructed in accordance with the teachings of the present invention;

FIG. 12 is a cross-sectional illustration of a prior pilot operated water valve;

FIG. 13 is a cross-sectional illustration of a prior L bracket used in the construction of the prior solenoid used in the valve of FIG. 12;

FIG. 14 is a top view illustration of the L bracket of FIG. 13; and

FIG. 15 is an end view illustration of the L bracket of FIG. 13.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

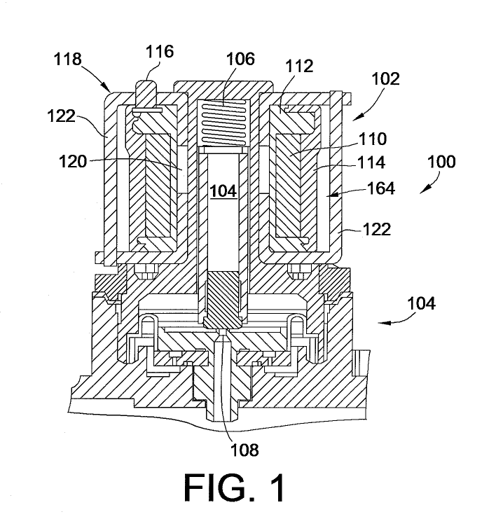

Turning now to the drawings, and particularly to FIG. 1, there is illustrated in partial cross-sectional form an embodiment of a pilot operated water valve 100 utilizing an embodiment of a solenoid 102 constructed in accordance with the teachings of the present invention. It should be noted, however, that while the following description will discuss various embodiments of the present invention in a particular operating environment, to wit a pilot operated water valve for a consumer appliance, applications of the teachings of the present invention may find use in other environments, and the exclusive right thereto is reserved in accordance with the claims appended hereto. In other words, the following exemplary embodiments should be taken by way of example and not by way of limitation.

The pilot operated water valve 100 illustrated in FIG. 1 includes a valving portion 104 and a solenoid 102. The valving portion 104 may take various forms and configurations known in the art, and therefore will not be described herein in detail. For example, such valving configurations may take the form of the V2 Series of pilot operated solenoid valves for use in clothes washers, dish washers, showers, air conditioning systems, and other domestic or commercial applications that is available from the assignee of the instant application.

The solenoid 102 of the pilot operated solenoid valve 100, when energized, moves the plunger 104 in a direction to compress spring 106 to open the pilot aperture 108 in order to open the valve in a manner that is well understood. The solenoid 102 includes a solenoid coil 110 wound on a bobbin 112. In one embodiment, the coil 110 is made of approximately 6750 turns of 40 AWG gauge copper wire. Such a coil 110 utilizes approximately 16 grams of copper, which presents a substantial reduction in the amount of copper required over prior coils, e.g. the coil 109 illustrated in FIG. 12 which has approximately 7055 turns of 38 AWG copper wire weighing approximately 28 grams. Such a substantial reduction in copper results in a significant reduction in cost of the coil 110, particularly in view of the high price of copper in today's environment.

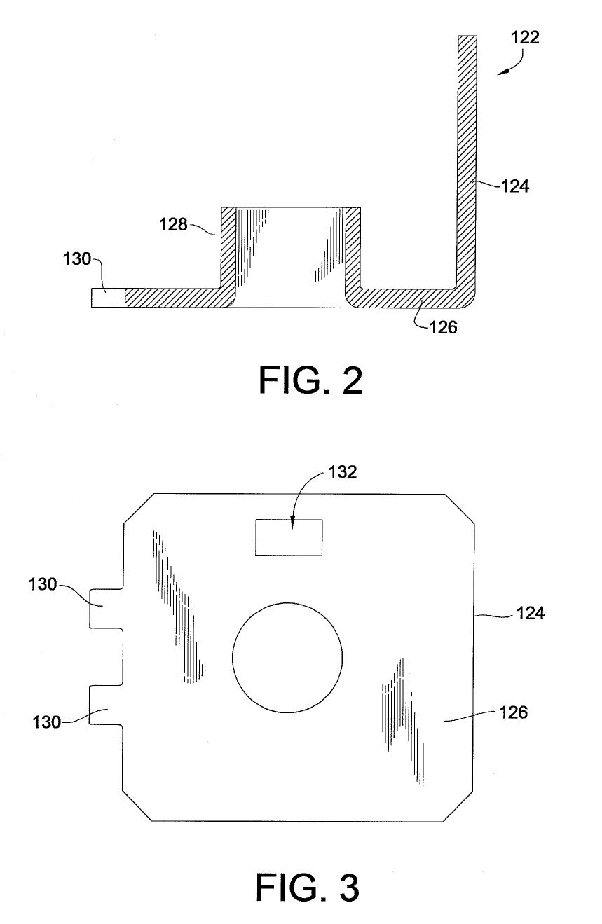

The coil 110 and bobbin 112 are then over molded within encapsulation 114, which may be plastic, resin, or other appropriate encapsulation material based on the operated environment in which pilot operated solenoid valve is to be installed. This encapsulation 114 may also include a locating tab 116 molded therein to aid in proper construction of the finished solenoid assembly. The solenoid 102 also includes a ferromagnetic pole frame 118 having an air gap 120 in the magnetic path thereof. In one embodiment of the present invention the ferromagnetic pole frame 118 is constructed from a pair of identical L brackets 122, the construction of which may best be understood through an analysis of FIGS. 2-4. While such identically provides significant manufacturing and parts stocking advantages, other embodiments of the present invention do not require that the L brackets be identical.

Turning for a moment to FIGS. 2-4, the L brackets 122 include a sidewall 124 approximately 22.5 mm tall and an end wall 126 approximately 30.5 mm wide. This structure provides a height to width ratio of approximately 0.73, which is significantly less than the ratio of the prior solenoid 101. As used herein, the height refers to a measure along the magnetic axis of the solenoid along which the plunger 104 moves, the width is a measure normal to the height that spans at least the diameter of the coil 110. Indeed, embodiments of the present invention utilize ratios that are less than one, preferably less than 0.8, and more preferably less than approximately 0.75. The depth of the end wall 126 as seen in FIG. 3 is approximately 27 mm. As such, the end wall 126 provides much more surface area to contact the end of the bobbin 112 than the prior bracket 121 of FIG. 14, which significantly helps with heat transfer as will be discussed more fully below. The thickness of each of the sidewall 124 and end wall is approximately 1.5 mm in the illustrated embodiment.

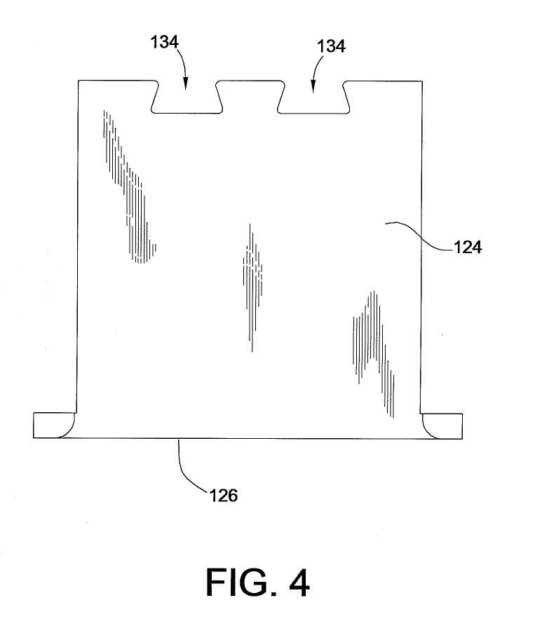

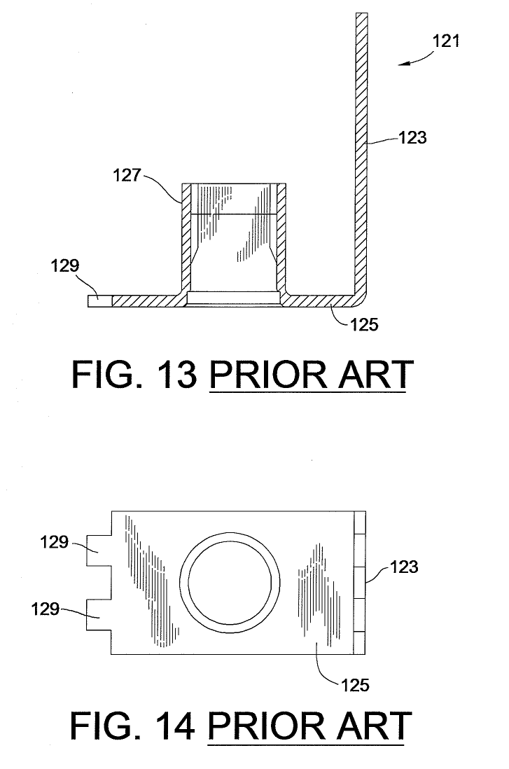

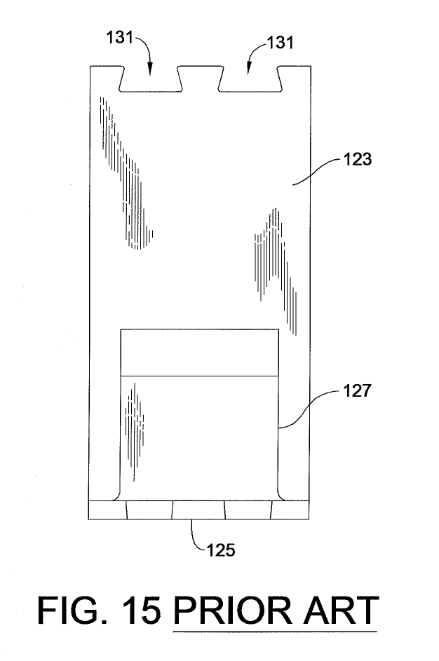

The L brackets 122 also include a centrally located draw 128 that is approximately 6.7 mm tall and has a wall thickness of approximately 1.1 mm. This draw 128 is significantly shorter than that of the draw 127 of the prior brackets 121 illustrated in FIG. 13, which results in less scrap material in the manufacturing process. The end wall 126 also includes, in one embodiment, a slot 132 sized to accommodate the locating pin 116 illustrated in FIG. 1. A pair of mating tabs 130 extend from end wall 126 and mate with the mating slots 134 seen in FIG. 4 formed on the sidewall 124. These cooperative structures 130, 134 allow two opposed L bracket to form the magnetic circuit 118 shown in FIG. 1.

Having now described the basic mechanical structure of an embodiment of the solenoid 102 constructed in accordance with the teachings of the present invention, the following will discuss the design rationale and unexpected results obtained during the design of the solenoid 102, a design effort that was driven by the need to reduce material costs in view of the skyrocketing cost of copper. However, the solenoid 102 must still be able to reliably open the pilot valve in the valving section 104, and must not have a degraded operational service life.

Recognizing that magnetic force is a function of the amperes of current multiplied by the number of turns of wire that is governed by the formula F=NI(Force=Number of Turns*Current)Ampere Turns, it was believed that the prior solenoid 101 configuration could be used with a reduced gauge wire for the coil 109 and a corresponding reduced number of turns (to maintain the same ampere turns) in order to achieve the copper material savings sought. While these changes do reduce the amount of copper used in the coil 109, it was discovered that the smaller wire gets hotter. The increased heat increases the stress on the coil 109 and ultimately is likely to reduce the operational life of the solenoid 101. Therefore, in designing the solenoid 102 of the present invention, the mechanical configuration of the solenoid 102 was changed such that it is shorter and fatter than the prior solenoid 101 to provide an unexpected thermal solution to the magnetic force design.

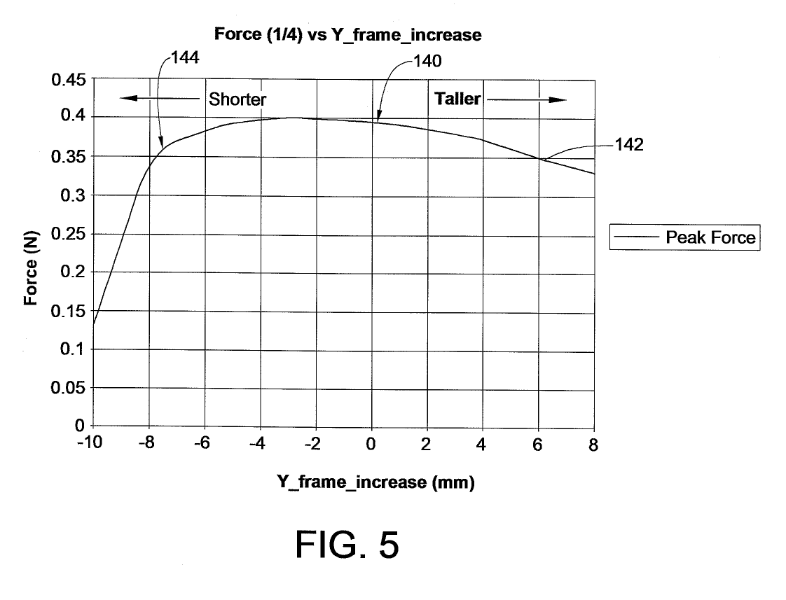

Recognizing that the mechanical configuration of the solenoid 101 of FIG. 12 having smaller gauge copper wire suffered from unacceptable thermal operation, variations of length and width were studied. To get the relationship of length to width, DC software modeling of a solenoid, holding ampere turns constant, was used and generated the graph illustrated in FIG. 5. While DC analysis neglects the effects of the inductance, it does give a relative comparison of length to width. Starting with the mechanical relationship of the prior solenoid 101 design located at point 140, the length was increased and decreased in the model to evaluate the effects on force, all other parameters held constant, which produced trace 142 illustrated in this FIG. 5.

The thermal benefits of a shorter coil dictated that the solenoid 102 of the present invention would need to be shorter than prior designs. Unfortunately, the magnetic performance decreases with the coil 110 getting shorter as may be seen from trace 142 as it moves closer to the vertical axis. One embodiment of the present invention utilizes a coil 110 that is 7.5 mm shorter (see point 144) than the prior coil 109 design. The 7.5 mm shorter coil 110 reached the diameter limit to maintain the overall pilot operated water valve 100 product profile to allow it to be interchangeable with the previous pilot operated water valve 99.

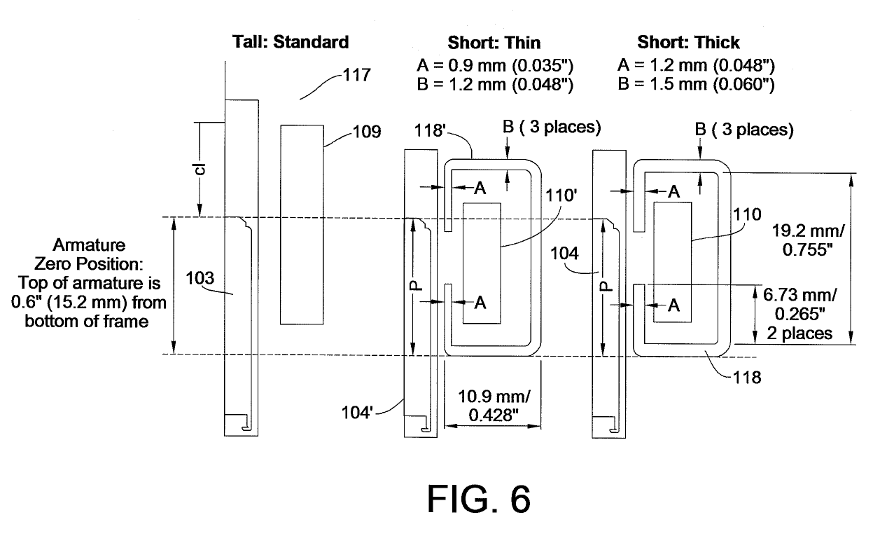

As illustrated in FIG. 6, which shows a simplified side-by-side comparison of the prior solenoid 101, one embodiment of a material-reduced solenoid 102′ having a “short” coil 110′ constructed in accordance with the teachings of the present invention, and one preferred embodiment of a solenoid 102 having a short coil 102 constructed in accordance with the teachings of the present invention, other aspects of the solenoid 102 design are different from prior solenoid 101 designs. Specifically, the starting location or zero position of the armature (plunger 103, 104′, 104) differ between the prior and current designs. The top of the plunger 103, 104′, and 104 are all at approximately 15 mm from the bottom of the ferromagnetic pole frame 117, 118′, 118 in each configuration in order to have the solenoid 102 be interchangeable with the prior solenoid 101 on the valving section 103. However, in view of the shorter pole frame 118′, 118, the location of the top of the plunger 104′, 104 relative to the coil 110′, 110 is significantly different in view of the total height of the shorter pole frames 118′, 118 and coils 110′, 110 being approximately 19 mm in the illustrated embodiments. The pole frame 118 thickness was also changed, unexpectedly and in contradiction of the effort to remove material cost from the design, to approximately 1.5 mm for the ends and sides, and 1.2 mm for the draw. These changes were made to maximize the magnetic force provided by embodiments of the present invention. However, a further unexpected benefit was also observed as will be discussed below.

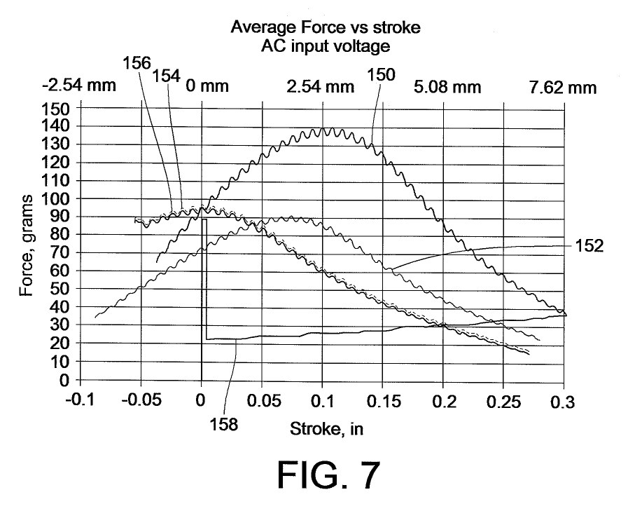

To determine the magnetic performance of embodiments of the present invention, additional magnetic modeling applies AC transient analysis which uses voltage sources, turns and coil resistance, and incorporates inductive effects on the ampere turns. FIG. 7 illustrates the average force versus stroke for a typical solenoid 101 having 7055 turns of 38 AWG copper wire (trace 150), a solenoid having the same mechanical configuration as solenoid 101 but with only 6750 turns of 40 AWG copper wire (trace 152), and two “short” solenoids having 6750 turns of 40 AWG copper wire, one having a thin pole frame 118′ and one with a thick pole frame 118 (traces 154, 156, respectively).

Also in this graphical illustration is a trace 158 representing the force required to move the plunger to open the pilot valve. Initial required opening force is generated by the water pressure combined with the spring force. Once opened, the coil must then overcome only the spring force.

As may be seen from a comparison of traces 150 and 158, the prior solenoid 101, in order to maximize opening distance, has its peak of the force curve (trace 150) not aligned with the peak of the required opening force curve (trace 158). Instead, the peak force generated is at approximately 2.54 mm of stroke. The solenoid 101 is sized to provide enough force at the initial opening to accomplish the task, but its force continues to rise to its peak as the actual needed force decreases after the initial opening and the solenoid 101 need only overcome the spring force.

By reducing the wire gauge, and subsequently the number of turns of copper, the peak of the force curve (trace 152) is adjusted to the height of the required opening force as may be seen from trace 158. However, since the air gap and armature geometry is the same as the prior solenoid 101, trace 152 does not have its peak force aligned with the plunger force curve (trace 158). Indeed, such a copper-reduced solenoid would likely not be able to open the pilot valve. However, as may be seen from traces 154, 156, each of the short solenoids have their peak force aligned with the force needed to open the plunger. While the short coils intersect the spring force curve at 5 mm (0.2 in) versus 7.5 mm (0.3 in) for the standard coil, this distance is more than adequate to open the valve fully.

As another significant disadvantage of a solenoid utilizing the same mechanical structure as solenoid 101 bur having less copper (fewer turns of smaller gauge wire), is that it runs much hotter, on the order of about 20° C. hotter, from the prior solenoid design. This presents a significant problem.

Quite unexpectedly, each of the two “short” coils constructed in accordance with the teachings of the present invention, both with thick and thin pole frames, adjusted for smaller gauge wire and having the peak of their force curves aligned with the peak force needed to open the pilot valve, have a steady state temperature that is significantly cooler than the prior solenoid 101, on the order of 10° C. In other words, the change of mechanical configuration of the solenoid having reduced copper ran approximately 30° C. cooler than the reduced copper solenoid keeping the prior mechanical configuration.

Further, using thicker steel in the L brackets 122 lowers the reluctance of the magnetic circuit. This causes the inductance to increase given the same number of turns of wire. As such, an embodiment of the present invention may have a further reduction of the number of turns to get back to the same magnetic force. Indeed, such thicker material will help in embodiments that are operated near saturation.

Given the same number of turns and resistance, the thicker material in the L brackets 122 actually has slightly less opening force. As such, one would not be motivated to use thicker material, especially since the driving force behind this design is material reduction to provide a cost savings. However, such a design uses proportionally less current. Therefore, more turns of copper wire, the high price material component, can be removed to bring both the force and current back to the same operating point as the thin material coil. These curves indicate that another ˜2% reduction in copper with the thicker material in the L brackets 122 may be achieved.

The L brackets 122 that direct the magnetic flux around the coil 110 also double as heatsinks. Heatsinks work by creating a low thermal impedance path to a large radiating surface. The shorter solenoid 102 provides a shorter path for the heat to escape from the copper wire of the coil 110. This shorter coil 110 has a larger contact surface area with the bobbin 112 and plastic encapsulation 114 on the end of the plastic coil assembly. As discussed above, this shorter solenoid also utilizes thicker steel in the L brackets 122, which would seem to be contrary to the effort of material cost reduction. However, the increased cross section of the thicker steel provides a wider, lower impedance, thermal path for the heat to get to the radiating surfaces on the exterior thereof. Indeed, the shorter solenoid 102 has more surface area from which to radiate the heat. As such, and as will be discussed more fully below, despite going contrary to the material cost reduction focus the thicker L brackets 122 provide superior performance.

While agency requirements, such as UL, list duty cycles and temperature limits for safety, the overall reliability of a valve 100 correlates to the valve temperature. Using steady state values as reference, reducing the wire gauge size from 38 AWG in the standard solenoid 101 to 40 AWG in one embodiment of the solenoid 102 of the present invention, maintaining the standard coil size (109) increased the temperature of the wire by 20° C. as discussed above.

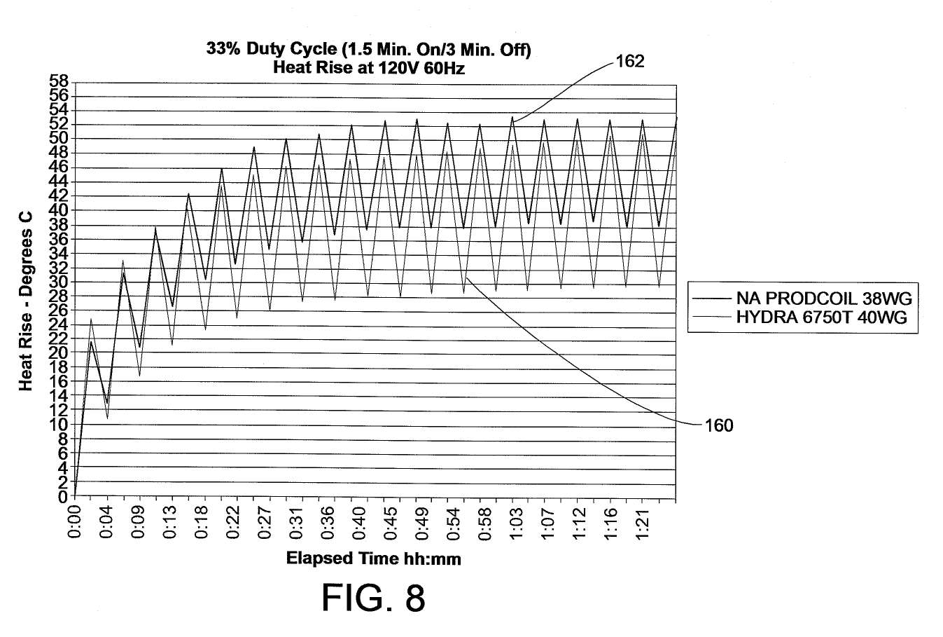

Using the short coil 110, the steady state temperature actually is reduced 10° C. As may be seen from FIG. 8, tests using the UL standard 1.5 minute on/3 minute off duty cycle show an average temperature (shown by trace 160) for the short coil 110 lower than the standard coil 109 (temperature shown by trace 162). Also to note, the temperature swing for the short coil 110 is higher. The increase in the upslope confirms that the coil 110 with the smaller gauge wire heats up faster, as expected. However, it also cools down faster, confirming the better thermal properties of the short solenoid 102, therefore the average duty cycle temperature is lower than the standard solenoid 101.

This thermal performance may be better understood by looking at the mechanical properties of the pole frames 117, 118. The external surface area of the prior solenoid 101 pole frame 117 is 16.8 cm² (2.6 in²). The short solenoid 102 pole frame 118 external radiating surface totals, in one embodiment, 23.2 cm² (3.6 in²). The short solenoid 102 L brackets 122 are also extended further away from the coil 110 and its encapsulation 114 to allow the internal surfaces room to radiate a little as may be seen from a comparison of gap 164 of FIG. 1 with gap 166 of FIG. 12.

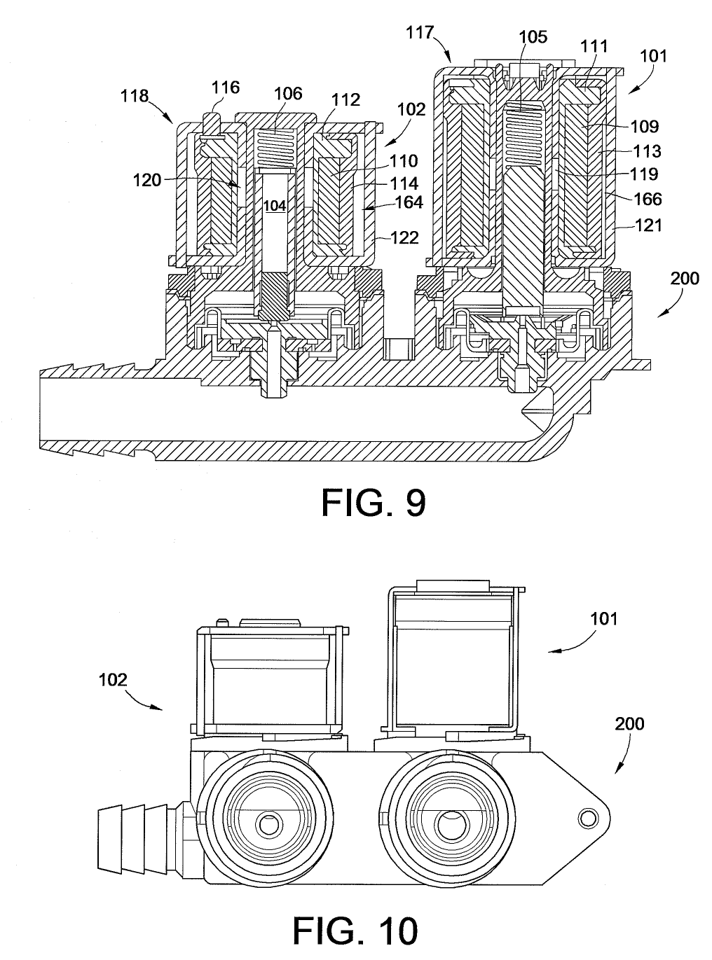

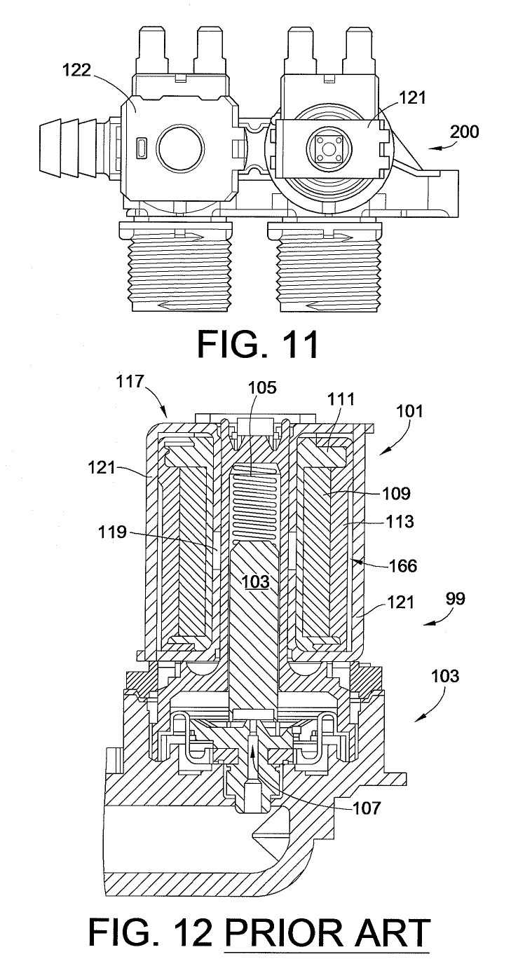

These gap 164, 166 differences may also be seen in FIGS. 9 and 10, which illustrate an exemplary pilot operated water mixing valve 200 constructed to show the physical differences between an embodiment of the short solenoid 102 of the present invention and the standard solenoid 101 in a side by side installation on a single pilot operated water mixing valve 200. The top view of FIG. 11 illustrates the much larger external surface area provided by the pole frame 118 of solenoid 102 as compared to the external surface area provided by the pole frame 117 of the prior solenoid 101.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A solenoid for a pilot operated water valve for use in an appliance, comprising:
a coil of 40 AWG copper wire;
a magnetic pole frame positioned around the coil in magnetic proximity thereto having a height to width ratio of less than one.

2. The solenoid of claim 1, wherein the magnetic pole frame has a frame depth spanning at least a majority of a diameter of the coil.

3. The solenoid of claim 2, wherein the magnetic pole frame has a surface area of greater than about 20 cm².

4. The solenoid of claim 3, wherein the surface area of the magnetic pole frame is approximately 23.2 cm².

5. The solenoid of claim 1, wherein the magnetic pole frame includes side and end walls and a draw portion formed therein, and wherein a wall thickness of the side and end walls is approximately 1.5 mm and the wall thickness of the draw portion is approximately 1.2 mm.

6. The solenoid of claim 1, wherein the coil contains approximately 6750 turns of 40 AWG copper wire.

7. The solenoid of claim 1, wherein the coil is constructed of less than 20 grams of copper.

8. The solenoid of claim 7, wherein the coil is constructed of approximately 16 grams of copper.

9. A pilot operated water valve, comprising:
a coil of 40 AWG copper wire;
a magnetic pole frame positioned around the coil in magnetic proximity thereto having a height to width ratio of less than one;
a plunger slidably positioned coaxial with a magnetic axis of the coil between a quiescent position wherein a first end is in contact with a pilot aperture and an activated position wherein the first end of the plunger is not in contact with the pilot aperture; and
a spring operably positioned in contact with a second end of the plunger to apply a bias force thereto to maintain the plunger in its quiescent position.

10. The pilot operated water valve of claim 9, wherein the magnetic pole frame has a frame depth spanning at least a majority of a diameter of the coil.

11. The pilot operated water valve of claim 10, wherein the magnetic pole frame has a surface area of greater than about 20 cm².

12. The pilot operated water valve of claim 11, wherein the surface area of the magnetic pole frame is approximately 23 cm².

13. The pilot operated water valve of claim 9, wherein the magnetic pole frame includes side and end walls and a draw portion formed therein, and wherein a wall thickness of the side and end walls is approximately 1.5 mm and the wall thickness of the draw portion is approximately 1.2 mm.

14. The pilot operated water valve of claim 9, wherein the coil contains approximately 6750 turns of 40 AWG copper wire.

15. The pilot operated water valve of claim 9, wherein the coil is constructed of less than 20 grams of copper.

16. The pilot operated water valve of claim 15, wherein the coil is constructed of approximately 16 grams of copper.

17. A solenoid for a pilot operated water valve for use in an appliance, comprising:
a coil of less than 38 AWG copper wire having less than seven thousand turns;
a magnetic pole frame positioned around the coil having a height to width ratio of less than one, a center draw less than 11 mm in length, a wall thickness of greater than 1.2 mm, and a surface area of greater than 17 cm².

18. The solenoid of claim 17, wherein the copper wire is 40 AWG copper wire and the turns are approximately six thousand seven hundred fifty turns.

19. The solenoid of claim 17, wherein the height to width ratio is about 0.73.

20. The solenoid of claim 17, wherein the center draw is approximately 6.7 mm in length, the wall thickness of the magnetic pole frame is about 1.5 mm and the surface area is about 23 cm².
